(19) United States
(12) Patent Application Publication
(10) Pub. No.: US 2012/0224003 A1
(43) Pub. Date: Sep. 6, 2012

(54) SHEET PROCESSING DEVICE

(75) Inventors: Daniel J.W. LINDENAAR, Venlo (NL); Jeroen J.G. Coenen, Venray (NL); Dedlef W.A Bartels, Venlo (NL)

(73) Assignee: OCE TECHNOLOGIES B.V.

(21) Appl. No.: 13/469,174

(22) Filed: May 11, 2012

Related U.S. Application Data
(63) Continuation of application No. PCT/EP2010/068072, filed on Nov. 24, 2009.

(30) Foreign Application Priority Data
Nov. 25, 2009 (EP) 09177044.6

(51) Int. Cl. B41J 23/00; B65H 3/08; B65H 3/34

(52) U.S. Cl. 347/37; 271/104

(57) ABSTRACT

A sheet processing device for processing a sheet-like print substrate comprising a sheet support surface for supporting at least a portion of a sheet; a fluid flow generator for inducing a fluid flow; a venturi-type underpressure source, comprising a first passage extending from an inlet to an outlet and a second passage connecting said first passage with a suction endpoint, wherein the connection between the first passage and second passage is located adjacent to a diametrical flow restriction within the first passage and wherein the sheet support surface comprises at least one aperture, which is in fluid communication with the suction endpoint of the venturi-type underpressure source such that in operation an underpressure is imposed on the sheet-like print substrate at the aperture holding at least a portion of the sheet-like print substrate down on the sheet support surface.

### FIELD OF THE INVENTION

The present invention is related to a sheet processing device for processing a sheet-like print substrate and to a method for holding down a sheet-like print substrate in a sheet processing device.

### BACKGROUND OF THE INVENTION

A typical example of such printing device is an inkjet printer where the image forming elements are constituted by print heads where the marking substance is in fluid form when discharged. Print heads usually each contain a plurality of nozzles arranged in (an) array(s). In operation, the nozzles are controlled to image-wise discharge fluid droplets of a marking substance on an substrate. When the printer is of the scanning type, the print heads are supported on a carriage which is moveable in reciprocation across the substrate, i.e. the main scanning direction. In such printers, the print heads are typically aligned in the sub scanning direction perpendicular to the main scanning direction. In a traverse of the carriage across the substrate a matrix of image dots of a marking substance, corresponding to a part of an original image is formed on the substrate by image-wise activating selected nozzles of the print heads. The printed matrix is generally referred to as a print swath, while the dimension of this matrix in the sub scanning direction is referred to as the swath width. Usually, although not required, the printing swath is constant within a selected printing mode. When a part of the image is completed, the substrate is displaced relative to the carriage carrying the print heads in the sub-scanning direction, enabling printing of a subsequent part of the image. When this displacement step is chosen equal to a swath width, an image can be printed in multiple non-overlapping swaths. An advantage of such approach is the high productivity as only a single printing stage is employed. However, image quality may be improved by employing printing devices enabling the use of multiple printing stages. Regardless whether the images are printed using a single traverse or multiple traverses of the print head, in-between traverses displacements between the substrate and the print heads are executed in small increments, the increment usually being equal to or smaller than a print swath width. It is of utmost importance in order to provide a consistent and acceptable image quality that these displacement steps can be reliably executed as even small displacement errors may introduce print artefacts such as e.g. white streaks and banding. It is therefore important to retain the substrate exactly once positioned in the print area in the plane of the support surface and in the direction towards the print heads. Touching the print heads with the substrate may result in smearing of the image, and increase the risk of damaging the typically delicate print heads. Retaining the position and orientation of the substrate is typically executed by a suction device positioned underneath the print area. In this type of suction devices a sub-ambient pressure is induced by powering a fan which sucks away air in a vacuum buffer in the suction device. This underpressure is typically provided to a plurality of apertures in the sheet support surface of the printing system, such that a substrate covering these apertures is hold down to the sheet support surface. After application of marking material to the substrate the vacuum is switched off, such that the substrate may be repositioned for the next swath or, after finishing the complete image, the substrate may be disposed from the sheet support surface.

However both applying as well as neutralizing the vacuum at the apertures in the sheet support surface typically takes some settling time, which substantially influences the productivity in between swaths or substrate switches. Furthermore the transport of underpressure from the underpressure source to the apertures significantly add to the cost and complexity of the sheet processing device, i.e. to transport the sub-ambient pressure to the medium retainment location, in general relatively thick piping is needed to maintain the underpressure and transport from underpressure source to the location at which the underpressure is required.

### SUMMERY OF THE INVENTION

The present invention provides a sheet processing device which in operation retains the print substrate reliable with a minimum influence on switching times.

According to a first aspect of the present invention, a sheet processing device for processing a sheet-like print substrate is disclosed, comprising a sheet support surface for supporting at least a portion of a sheet, a fluid flow generator for inducing a fluid flow, a venturi-type underpressure source, comprising a first passage extending from an inlet to an outlet and a second passage connecting said first passage with a suction endpoint, wherein the connection between the first passage and second passage is located adjacent to a diametrical flow restriction within the first passage and wherein the sheet support surface comprises at least one aperture, which is in fluid communication with the suction endpoint of the venturi-type underpressure source such that in operation an underpressure is imposed on the sheet-like print substrate at the aperture holding at least a portion of the sheet-like print substrate down on the sheet support surface.

It is an advantage of this sheet processing device that the vacuum is created relatively instantaneously by switching on the fluid flow generator for inducing the fluid to flow. The invention further enables the sub-ambient pressure to be generated relatively close to the location at which the underpressure is required. It is in general easier to transport a flow of fluid than to transport an underpressure from source to aperture. By using a venturi-type underpressure source in a sheet processing device according to the present invention a high underpressure can be achieved with a relatively low flow. This contributes to a relatively low influence of underpressure leakage, e.g. in case that the sheet-like print substrate does not cover all apertures at which the underpressure is imposed.

In an embodiment of the present invention the sheet processing device further comprises a flow restricting valve which is mounted between the fluid flow generator and the inlet of the venturi-type underpressure source, which flow restricting valve is configured to -in operation- controllably inhibit the fluid to flow from the fluid flow generator to the inlet of the venturi-type underpressure source. By switching the flow restricting valve to an inhibiting state, results in no fluid flowing through the venturi-type underpressure source the underpressure instantaneously stops building up the underpressure at the aperture. Switching the flow restricting valve to an open state, results in a flow through the venturi-type underpressure source and an underpressure starts building up substantially instantaneously at the aperture which retains the sheet-like print substrate.

In an embodiment of the present invention the sheet processing device an open vacuum buffer space at the aperture to buffer a build-up underpressure between the venturi-type underpressure source and the aperture which retains the sheet-like print substrate. By employing a vacuum buffer space small fluctuations in underpressure may be compensated such that a more constant underpressure is maintained at the aperture. The vacuum buffer space may be relatively small, e.g. a small chamber directly under the aperture in the sheet support surface such as an cup-shaped open buffer space embossed in the sheet support surface, or may comprise a relatively larger space which may span a plurality of apertures.

In an embodiment of the present invention the sheet processing device further comprises ventilation means for controllably neutralizing a build-up underpressure at the suction endpoint. Although inhibiting the flow of fluid through the venturi-type underpressure source substantially instantaneously stops the build-up of underpressure at the suction endpoint, adding ventilation means may contribute to faster switching between retaining a sheet-like print substrate and disengaging the sheet-like print substrate, e.g. to allow transport of the sheet-like print substrate. Control of the ventilation means may be implemented by a connection between the ventilation means and a control unit, e.g. electrically, optically, mechanically, pneumatically, or otherwise. The control unit may be implemented as a single unit or be distributed throughout and even remote from the sheet processing device. By switching the ventilation means to a state in which the suction endpoint is ventilated, ambient air is allowed to flow in between the venturi-type underpressure source and the sheet-like print substrate such that the pressure at the suction endpoint is neutralized to ambient pressure. In a further embodiment the ventilation means are controllably in fluid communication with the fluid flow from the fluid flow generator. This means by switching the ventilation means to a state in which the suction endpoint is ventilated, pressurized air is allowed to flow in between the venturi-type underpressure source and the sheet-like print substrate such that the pressure at the suction endpoint is neutralized to ambient pressure or even to a slight over-pressure, allowing an even speedier release of the sheet-like print substrate from the aperture at the sheet support surface. The valve switching the ventilation means may be a separate valve or be a two-state valve, e.g. a valve which leads the fluid flow to the venturi-type underpressure source in a first state of the valve, and leads the compressed fluid flow to the ventilation means in a second state of the valve. The latter stops building up the underpressure at the suction endpoint when the ventilation means are switched off.

In an embodiment of the present invention the sheet processing device further comprises a plurality of compartments which are separately operated by individual fluid flows, e.g. hoses feeding pressurized air from an over-pressure source to the individual compartments. It shall be clear to a person skilled in the art that any source of pressurized fluid may act as a fluid flow generator. The sheet processing device may comprise a single fluid flow generator or a plurality thereof.

In another aspect the invention relates to an ink jet printer comprising a sheet processing device according to any one of preceding claims, further comprising a carriage being moveable in reciprocation in a main scanning direction over at least a portion of the sheet support surface and carrying at least one print head, each print head having a plurality of discharging elements for image-wise forming dots of a marking substance in an imaginary print area of the print substrate in a traverse in the main scanning direction, wherein the print area of the print substrate is hold down onto the sheet support surface by means of suction. In ink jet printing it is of utmost importance that a sheet-like print substrate is retained in a required position both in the plane of the sheet-like print substrate as well as perpendicular to the plane of the sheet-like print substrate, as a contact between a sheet-like print substrate and a print head may damage or even destroy the print head.

In another aspect of the present invention relates to a method for holding at least a portion of a sheet-like print substrate down in a sheet processing device, comprising the steps of a) providing a portion of the sheet-like print substrate to cover an aperture in a sheet support surface of the sheet processing device, which aperture is in fluid communication with a venturi-type diametrical flow restriction; and step b) inducing a fluid to flow through the venturi-type diametrical flow restriction, thereby creating a sub-ambient pressure.

### BRIEF DESCRIPTION OF THE DRAWINGS

FIG. 1 is a schematic top view of a hybrid flatbed and roll to roll inkjet printer provided with a sheet processing device according to an embodiment of the present invention;

FIG. 2 is a schematic view of a sheet processing device comprising a venturi-type underpressure source according to an embodiment of the present invention;

FIG. 3 is a schematic view of a hybrid flatbed and roll to roll inkjet printer provided with a sheet processing device according to an embodiment of the present invention;

FIG. 4 is a schematic view of a sheet processing device comprising a venturi-type underpressure source comprising ventilation means according to an embodiment of the present invention;

FIG. 5 is a schematic view of a sheet processing device comprising a venturi-type underpressure source comprising a ventilation valve according to an embodiment of the present invention.

FIG. 6 is a schematic view of a sheet processing device comprising a venturi-type underpressure source according to an embodiment of the present invention.

FIG. 7 is a schematic view of a sheet processing device comprising a venturi-type underpressure source comprising an elastic pressure seal according to an embodiment of the present invention.

### DETAILED DESCRIPTION OF THE INVENTION

In relation to the appended drawings, the present invention is described in detail in the sequel. Several embodiments are disclosed. Although in the embodiments disclosed, the marking substance is an UV curable ink, the radiation sources are mercury lamps, and the substrate is paper, it is apparent however that a person skilled in the art can imagine several other equivalent embodiments or other ways of executing the present invention. In particular, the marking substance may be any marking substance which can be discharged in fluid form including but not limited to a solvent or aqueous based ink, a radiation curable ink, a liquid toner, a hot melt ink, while the radiation source may be a drying source including a halogen lamp or a curing source including mercury vapour lamps, xenon flash lamps, and LED's. The substrate can be a flexible or a rigid medium in web or in sheet form and may be composed of e.g. paper, cardboard, label stock, plastic or textile. Hence, the scope of the present invention is limited only by the terms of the appended claims.

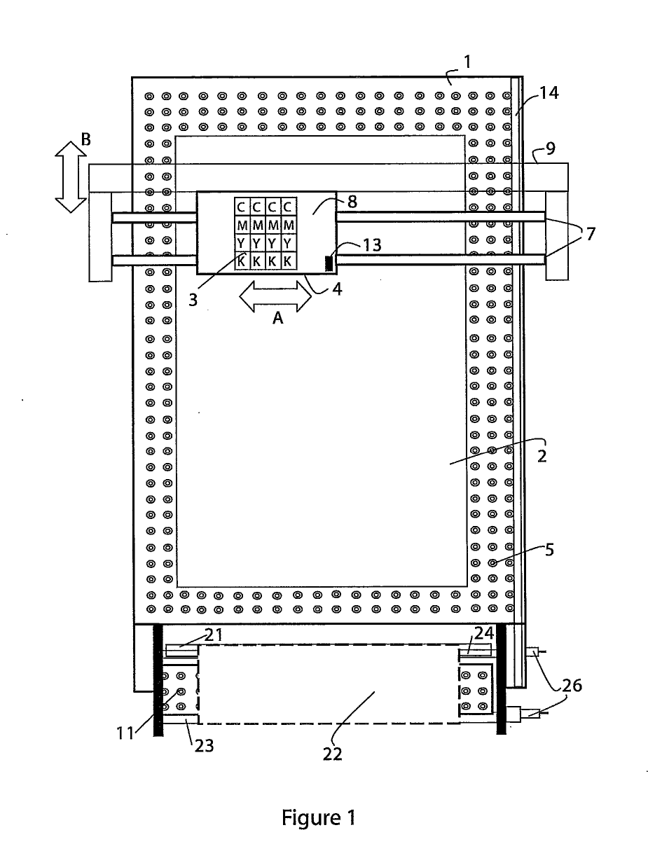

The printing device of FIG. 1 is a hybrid inkjet printer, i.e. a combined flatbed type and roll to roll printer using an UV curable ink as marking substance. The flatbed part of the printer comprises a flat support table (1) for supporting and keeping a paper sheet 2 stationary when printing. Underneath the table is a reservoir where air is maintained at a pressure well below atmospheric pressure. The support table includes a perforated metal plate having an upper surface contacting the paper sheet. The apertures 5 cause the paper sheet to be sucked against the surface of the table. The apertures 5 in the metal plate typically have a diameter of about 1 mm. Typically about 400 perforations per m² are formed. In the upper surface of the metal plate, larger recesses are formed having a diameter of about 5 mm, each recess surrounding an aperture. Several print heads 3, are mounted on a carriage 4 which can be moved in reciprocation along a guide member 7 extending across the substrate, i.e. the main scanning direction.

The print heads 3 of a particular colour, e.g. black (K), cyan (C), magenta (M), yellow (Y), are arranged in the main scanning direction, i.e. the direction indicated by arrow A, while print heads of different colours are aligned substantially in the sub scanning direction as indicated by arrow B. Each print head comprises a number of discharging elements which are typically arranged in a single array or in multiple arrays in the sub scanning direction. Each discharging element is connected via an ink duct to an ink reservoir of the corresponding colour. Each ink duct is provided with means for activating the ink duct and an associated electrical drive circuit. For instance the ink duct may be activated thermally, and/or piezoelectrically, or acoustic, or electrostatically. When the ink duct is activated an ink drop is discharged form the discharge element in the direction of the table 1 and forms a dot of ink on the substrate.

The carriage further supports two radiation sources 8 for irradiating the ink dots deposited on the substrate. The guide member 7 may consist of two parallel cylindrical rods where the carriage is suspended on. The guide member and the carriage are both part of a gantry 9. This gantry can be moved back and forth along the substrate, i.e. in the sub scanning direction. The support table 1 and the substrate thereon are both is kept stationary.

In operation the gantry is first displaced to an initial printing position such that e.g. the carriage is positioned in the upper left corner of the support table 1. Then, dependent upon the printing mode chosen, a print swath is formed by image-wise activating selected discharging elements of the print heads in relation to the pattern(s) of pixels of an image or document to be reproduced, while the carriage is moved across the substrate in one or more traverses. With UV curable inks there is a minimum dose of energy that is required to cure the ink. The mercury vapour lamps 8 schematically indicated in FIG. 1 irradiate at least the ink dots deposited while the print swath progresses and have a dimension in the sub-scanning direction slightly greater than the print swath width, i.e. the width of image dots formed by the print heads on the substrate in a traverse of the carriage across the substrate.

When a print swath is completed the print heads are step-wise displaced in the sub scanning direction to enable printing of a next contiguous or partially overlapping print swath. Hence the incremental advancement of the print heads relative to the substrate is smaller than or equal to the width of the previous print swath. As the print heads are mounted to the carriage and the carriage is suspended on the gantry the displacement of the print heads in the sub scan direction is effected by displacing the gantry.

Drive means are provided to accurately displace the gantry. These drive means include two endless metal belts operatively associated with the gantry such that by moving the belts also the gantry is moved. These belts are positioned at both sides of the table 1 below the table surface and extend in the sub-scanning direction. Two pulleys positioned at opposite ends of the belt carry each belt. One pulley is used for driving the belt, while the other pulley is used for guiding and tensioning the belt. To limit skew when displacing the gantry, the drive pulleys of each of the belts are substantially identical. Furthermore to ensure that the drive pulleys of both belts are driven simultaneously a metal rod is provided which is at each end operatively connected to a drive pulley such that rotary motion of the rod is transferred to the drive pulleys. The rod itself is driven near its centre or alternatively off centre e.g. at one end thereof. This drive means ensures that the print heads can be positioned precisely not only at any position above the support table 1 of the flatbed part of the printer but also at any position above the support of the roll to roll part of the printer.

To enable proper control of the gantry positioning and hence the positioning of the print heads, a high precision linear encoder 14 is provided on the flatbed support 1 extending along the table surface in the sub scanning direction. This linear encoder may also be mounted underneath the table or to a table side extending in the sub scanning direction. This linear encoder is a high precision ruler provided with micrometer spaced marks. An optical detector 13 is provided on the carriage which together with the ruler allows to determine the gantry/carriage/print head position within micrometer range. In case the linear encoder is mounted underneath the table or to a table side, the optical detector is preferably mounted to the gantry. Together with the accurate drive means a gantry positioning accuracy of about 10 μm or even below can be achieved.

Besides the flatbed part which allows for printing on an stationary substrate, the printer as depicted in FIG. 1 also contains a roll to roll part having a separate support 11 for carrying and a temporarily holding a moveable substrate such that printing can be executed thereon. The substrate transport path in the roll to roll part of the printer is relatively simple. The substrate, i.e. a paper web 22, is advanced from a paper supply roll 21 over support 11 to take-up roll. The transport path defined in this way is a continuous path. Drive motors 26 are used for the rotary motion of the supply roll and the take-up roll respectively. The paper advancement and the paper tensioning is hence controlled by controlling the drive motors. Roller 23 and curved surface 24 are provided to facilitate the paper guidance. Moreover, roller 23 is provided with an elastomeric outer layer for contacting the back of the paper in a slipless manner. Furthermore a high precision rotary encoder is provided at one end of roller 23 in order to measure paper advancement. Instead or in addition to this encoder associated with roller 23 a rotary encoder may also be provided on the supply roll 21 in order to determine or at least assist in determining the paper advancement. Alternatively instead of roller 23 also a grid wheel may be used to measure the paper advancement.

In operation first a continuous paper path is formed between the supply and take-up roll. Then, the gantry is displaced using the drive means as previously described to an initial printing position, e.g. such that the print heads are positioned above the paper on the support 11 about halfway the support 11 in the paper transport direction. Then, dependent upon the printing mode chosen, a print swath is formed by image-wise activating selected discharging elements of the print heads in relation to the pattern(s) of pixels of an image or document to be reproduced, while the carriage is moved across the paper 22 on support 11 in one or more traverses. The mercury vapour lamps 8 schematically indicated in FIG. 1 irradiate at least the ink dots deposited while the print swath progresses and have a dimension in the sub-scanning direction slightly greater than the print swath width, i.e. the width of image dots formed by the print heads on the substrate in a traverse of the carriage across the substrate.

According to an embodiment of the invention, when a print swath is completed the paper is stepwise advanced in the sub scanning direction over a predetermined distance to enable printing of a next contiguous or partially overlapping print swath. Subsequently the actual paper advancement distance is measured by means of the rotary encoder associated with roller 23 and/or the rotary encoder associated with the supply roll 21. This actual advancement distance is compared with the predetermined distance and based thereon a correction distance is determined. Then the gantry cq the carriage cq the print heads are displaced over this correction distance in the sub scanning direction such that the actual advancement distance of the paper relative to the print heads equals the predetermined distance and thus the next print swath may be executed. To displace the gantry precisely over the correction distance use is made of the same drive and control means as describe earlier in relation to the flatbed operation.

This sequence of executing a print swath, advancing the paper, position detection and position correction by displacing the gantry is repeated till a complete image is printed. Alternatively, according to another embodiment of the invention, instead of advancing the substrate after each print swath, the printer may be operated such that plural print swaths are executed prior to the substrate advancement or in other words the substrate advancement and accompanying correction as described in the previous embodiment is only executed after each sequence of two or three or four print swaths or as many as the support dimension and gantry reach allow. Instead of displacing the substrate in-between print swaths of a sequence, the gantry is displaced with respect to the substrate on the support 11. Support 11 and table 1 comprise apertures 5 which are in fluid communication with a venturi-type underpressure source according to the present invention.

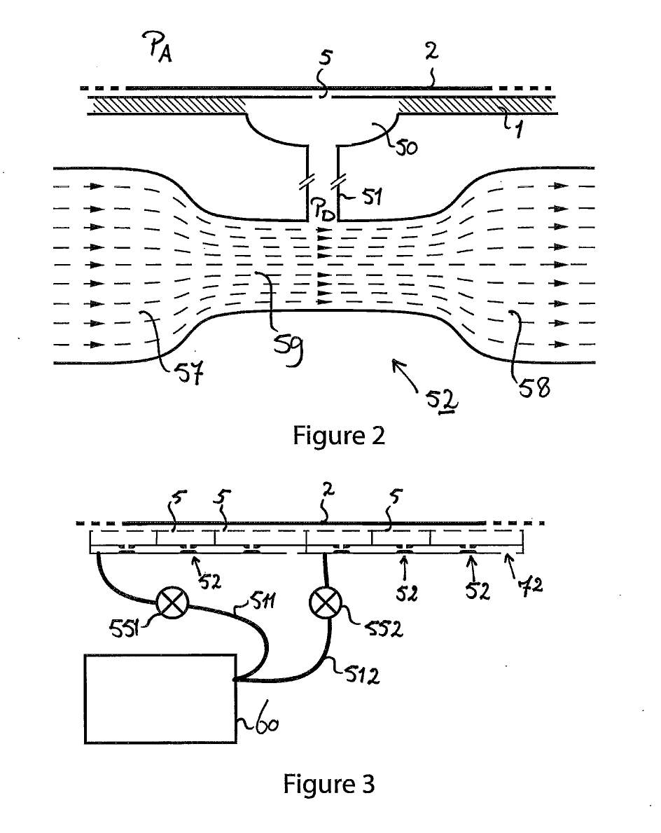

FIG. 2 is a schematic view of a sheet processing device comprising a venturi-type underpressure source according to an embodiment of the present invention. FIG. 2 illustrates schematically how the sheet-like print substrate 2 is retained onto the table 1. Table 1 comprises apertures 5 which connect the upper plane of the table 1 to a venturi-type underpressure source 52. A venturi-type underpressure source 52 comprises a passage extending from inlet 57 to outlet 58. Inlet 57 is in fluid communication with a fluid flow generator, such as in this case an air compressor (not shown). Said passage comprises a diametrical flow restriction 59. This diametrical flow restriction 59 is a part of said passage which has a smaller diameter than the part of the passage at the inlet of the venturi-type underpressure source 52. In the diametrical flow restriction 59 the fluid passing through will attain a higher velocity at the diametrical flow restriction 59 than at the inlet 57 and as a physical result thereof at the diametrical flow restriction 59 of the venturi-type underpressure source 52 the dynamic pressure of the fluid passing through will lower. By designing the dimensions of the venturi-type underpressure source 52 appropriately, the pressure P_{D} at the diametrical flow restriction will attain a sub-ambient value, resulting in an underpressure with respect to the ambient pressure P_{A}. The underpressure P_{D} will propagate into conduit 51 which connects the diametrical flow restriction 59 indirectly via the optional buffer chamber 50 with aperture 5, or in an alternative embodiment directly to aperture 5. Buffer chamber 50 is a pressure buffer which equalizes the actual pressure over time.

FIG. 3 is a schematic view of a hybrid flatbed and roll to roll inkjet printer provided with a sheet processing device according to an embodiment of the present invention. Fluid flow generator 60 generates a flow of pressurized air which flows via conduits 511 and 512 towards valves 551 and 552. Valves 551 and 552 controllably inhibit the flow towards the plurality of venturi-type underpressure sources 52 or in an open state they let the flow pass through. Control of the valves 551 and 552 is implemented electrically. By sending an electrical signal to the valves 551 and 552 the valves switch from an open to a closed state and vice versa. It will be clear that control of said valves may alternatively be implemented optically, mechanically, pneumatically or otherwise. Please note that although the figure shows six venturi-type underpressure sources 52, this is just illustrative. In practise the system may well comprise other amounts of venturi-type underpressure sources 52. The pressurized air from the fluid flow generator 60 flows into both compartments—although other amounts of compartments may exist in practise—and flow from conduit 511 to exit 71 in the first compartment and from conduit 512 to exit 72 in the second compartment. The venturi-type underpressure sources 52 are in fluid connection with the apertures 5 via buffer chambers each connected to one or more apertures 5. The exits 71 and 72 may alternatively be implemented as a return conduit to the fluid flow generator to form a closed flow circuit of pressurized fluid.

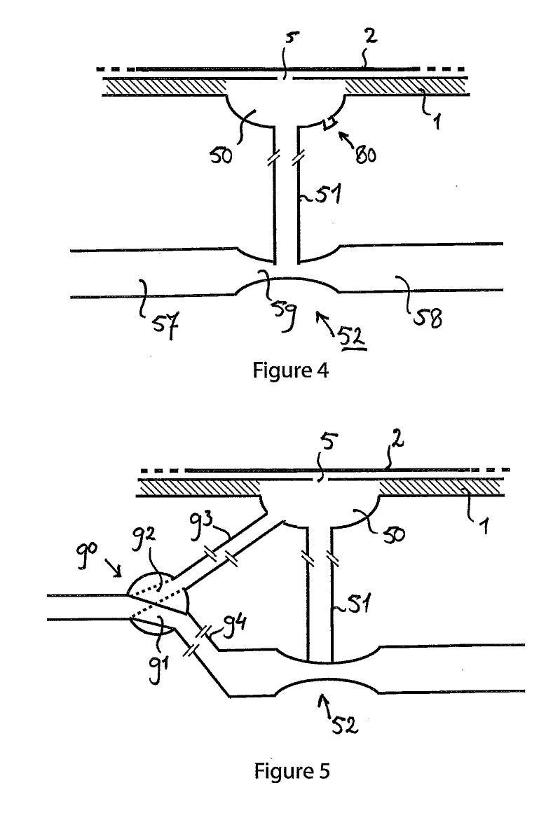

FIG. 4 is a schematic view of a sheet processing device comprising a venturi-type underpressure source comprising ventilation means according to an embodiment of the present invention. The embodiment is quite similar to the embodiment of FIG. 2, however this embodiment comprises ventilation means 80 for neutralizing the underpressure at the suction endpoint near the aperture 5. In this embodiment the ventilation means comprise an air valve 80 which controllably open the passage to the buffer chamber 50 to the ambient air to flow into the buffer chamber 50 thereby neutralizing the underpressure build-up by the venturi-type underpressure source 52.

FIG. 5 is a schematic view of a sheet processing device comprising a venturi-type underpressure source comprising a ventilation valve according to an embodiment of the present invention. This embodiment comprises a valve 90 to control the pressurized air to flow either to the venturi-type underpressure source 52 through conduit 94 if the valve is set to state 91, or to conduct the pressurized air to flow through the ventilation conduit 93 into the buffer chamber 50 in state 92. By controllably switching valve 90 to either state 91 or 92 the system can decrease switching times of the vacuum attraction of the sheet-like print substrate 2 onto the table 1. By decreasing the switching times needed for engaging and disengaging underpressure to the aperture 5 less time is consumed in processes such as transport of the sheet-like print substrate 2 to its next position in transport direction.

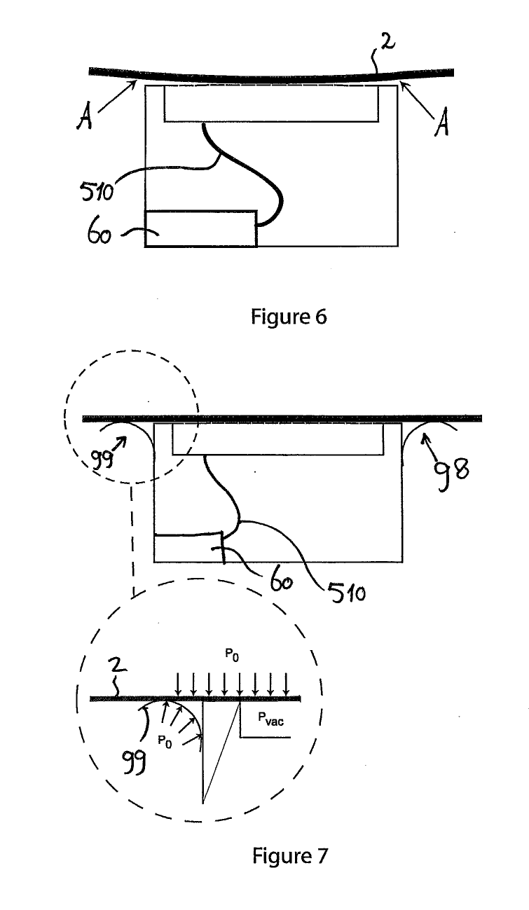

FIG. 6 is a schematic view of a sheet processing device comprising a venturi-type underpressure source according to an embodiment of the present invention. In FIG. 6 a sheet-like print substrate 2 is supported on a sheet processing device. However, in practise some sheet-like print substrate types tend to curl due to e.g. (de-)moisturization, directional thermal effects or the like. In particular stiff media such as printing rigids, may create an air flow leakage A between the sheet-like print substrate 2 and the suction apertures of the sheet processing device. Air flow leakage locally neutralizes or reduces the underpressure at the suction apertures, and losen the grip of the underpressure device resulting in less control over the sheet-like print substrate. FIG. 7 is a schematic view of a sheet processing device comprising a venturi-type underpressure source comprising an elastic pressure seal according to an embodiment of the present invention. The elastic pressure seal 98, 99 is configured to be mounted on the side of the sheet processing device and seals at least partially the potential leakage of underpressure as illustrated in the zoomed circular dashed cut-out. The ambient pressure P₀ presses the elastic seal towards the sheet-like print substrate and closes the gap that would have occurred if the seals would be absent for curled media and in general for media that do not lay completely over the suction holes in general. By configuring the elastic seals such that the side pointing upstream the media transport direction is bend at an angle, a sheet-like print substrate easily slides over the elastic seals 98, 99 from the upstream direction when supplied to the suction area.

In general it may be appreciated that the underpressure which retains the sheet-like print substrate may be varied over time, in that it can be switched on and off completely or alternatively it may also be switched gradually to a higher or lower underpressure. This may be particularly advantageous in case the sheet-like print substrate is to be intermittingly transported and retained, e.g. retained during a printing operation and transported in between subsequent print swaths.

The underpressure may be uniform over the width of the sheet processing device or may be varying over the width, e.g. the highest underpressure in the centre of the sheet support surface and decreasing towards the side edges of the support surface. It may alternatively also vary in time, e.g. an increased underpressure at the moment when an ink head moves over the specific spot of the support surface and decreased when the ink head is not over the spot. It will be clear that these variations may occur stand-alone or in combination with each other. To increase the sealing of the suction apertures by the sheet-like print substrate, an air blowing air knife may be mounted above the sheet-like print substrate, e.g. on the scanning carriage such that the medium is pushed onto sheet support surface and additionally to provide extra cooling or air flow to increase curing if desired. The support area on which the sheet-like print substrate is supported may be completely flat or profiled. A profiled support surface may be advantageous to equalize the underpressure over a larger area when using e.g. a porous print substrate. The support surface may be grooved in transport of lateral direction or otherwise profiled. It may be advantageous to close the non-covered apertures to decrease the influence of leakage. An operator may e.g. cover the areas which are not covered by the sheet-like print substrate with another covering sheet, or alternatively a valve may be implemented, such as e.g. disclosed in U.S. Pat. No. 4,378,155 to automatically close the airflow if the suction aperture is not covered.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims and/or embodiments may be applied in combination and any combination of such claims and/or embodiments are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

1. Sheet processing device for processing a sheet-like print substrate comprising:
a sheet support surface for supporting at least a portion of a sheet;
a fluid flow generator for inducing a fluid flow;
a venturi-type underpressure source, comprising a first passage extending from an inlet to an outlet and a second passage connecting said first passage with a suction endpoint, wherein the connection between the first passage and second passage is located adjacent to a diametrical flow restriction within the first passage;
and wherein the sheet support surface comprises at least one aperture, which is in fluid communication with the suction endpoint of the venturi-type underpressure source such that in operation an underpressure is imposed on the sheet-like print substrate at the aperture holding at least a portion of the sheet-like print substrate down on the sheet support surface.

2. Sheet processing device according to claim 1, further comprising a flow restricting valve mounted between the fluid flow generator and the inlet of the venturi-type underpressure source, configured to in operation controllably inhibit the fluid to flow from the fluid flow generator to the inlet of the venturi-type underpressure source.

3. Sheet processing device according to claim 1, wherein the aperture comprises an open vacuum buffer space embossed in the sheet support surface.

4. Sheet processing device according to claim 3, wherein the open vacuum buffer space comprises an open cup-shaped embossed space.

5. Sheet processing device according to claim 1, further comprising ventilation means for controllably neutralizing the underpressure at the suction endpoint.

6. Sheet processing device according to claim 5, wherein the ventilation means are controllably in fluid communication with the fluid flow from the fluid flow generator.

7. Ink jet printer comprising a sheet processing device according to claim 1, further comprising a carriage being moveable in reciprocation in a main scanning direction over at least a portion of the sheet support surface and carrying at least one print head, each print head having a plurality of discharging elements for image-wise forming dots of a marking substance in an imaginary print area of the print substrate in a traverse in the main scanning direction, wherein the print area of the print substrate is hold down onto the sheet support surface by means of suction.

8. Method for holding at least a portion of a sheet-like print substrate down in a sheet processing device, comprising the steps of
a) providing a portion of the sheet-like print substrate to cover an aperture in a sheet support surface of the sheet processing device, which aperture is in fluid communication with a venturi-type diametrical flow restriction
b) inducing a fluid to flow through the venturi-type diametrical flow restriction, thereby creating a sub-ambient pressure.

9. Method according to claim 8, further comprising the step of controlling a flow inhibitor to substantially inhibit the fluid to flow through the venturi-type diametrical flow restriction.

10. Method according to claim 8, further comprising the step of ventilating the aperture to neutralize the sub-ambient pressure at the aperture.

11. Sheet processing device according to claim 2, wherein the aperture comprises an open vacuum buffer space embossed in the sheet support surface.

12. Sheet processing device according to claim 3, wherein the aperture comprises an open vacuum buffer space embossed in the sheet support surface.

13. Sheet processing device according to claim 2, further comprising ventilation means for controllably neutralizing the underpressure at the suction endpoint.

14. Sheet processing device according to claim 3, further comprising ventilation means for controllably neutralizing the underpressure at the suction endpoint.

15. Sheet processing device according to claim 4, further comprising ventilation means for controllably neutralizing the underpressure at the suction endpoint.

16. Ink jet printer comprising a sheet processing device according claim 2, further comprising a carriage being moveable in reciprocation in a main scanning direction over at least a portion of the sheet support surface and carrying at least one print head, each print head having a plurality of discharging elements for image-wise forming dots of a marking substance in an imaginary print area of the print substrate in a traverse in the main scanning direction, wherein the print area of the print substrate is hold down onto the sheet support surface by means of suction.

17. Ink jet printer comprising a sheet processing device according to claim 3, further comprising a carriage being moveable in reciprocation in a main scanning direction over at least a portion of the sheet support surface and carrying at least one print head, each print head having a plurality of discharging elements for image-wise forming dots of a marking substance in an imaginary print area of the print substrate in a traverse in the main scanning direction, wherein the print area of the print substrate is hold down onto the sheet support surface by means of suction.

18. Ink jet printer comprising a sheet processing device according to claim 4, further comprising a carriage being moveable in reciprocation in a main scanning direction over at least a portion of the sheet support surface and carrying at least one print head, each print head having a plurality of discharging elements for image-wise forming dots of a marking substance in an imaginary print area of the print substrate in a traverse in the main scanning direction, wherein the print area of the print substrate is hold down onto the sheet support surface by means of suction.

19. Ink jet printer comprising a sheet processing device according to claim 5, further comprising a carriage being moveable in reciprocation in a main scanning direction over at least a portion of the sheet support surface and carrying at least one print head, each print head having a plurality of discharging elements for image-wise forming dots of a marking substance in an imaginary print area of the print substrate in a traverse in the main scanning direction, wherein the print area of the print substrate is hold down onto the sheet support surface by means of suction.

20. Ink jet printer comprising a sheet processing device according to claim 6, further comprising a carriage being moveable in reciprocation in a main scanning direction over at least a portion of the sheet support surface and carrying at least one print head, each print head having a plurality of discharging elements for image-wise forming dots of a marking substance in an imaginary print area of the print substrate in a traverse in the main scanning direction, wherein the print area of the print substrate is hold down onto the sheet support surface by means of suction.
